(19) United States
(12) Patent Application Publication
(10) Pub. No.: US 2014/0354765 A1
(43) Pub. Date: Dec. 4, 2014

(54) MULTIPOINT CONTROL UNIT AND SERVICE PROVIDING METHOD THEREOF

(71) Applicant: Electronics and Telecommunications Research Institute, Daejeon (KR)

(72) Inventor: Jong Hwa YI, Daejeon (KR)

(73) Assignee: Electronics and Telecommunications Research Institute, Daejeon (KR)

(21) Appl. No.: 14/029,121

(22) Filed: Sep. 17, 2013

(30) Foreign Application Priority Data
May 30, 2013 (KR) 10-2013-0062018

(51) Int. Cl. H04N 7/15

(52) U.S. Cl. CPC H04N 7/152
USPC 348/14.09

(57) ABSTRACT

A multipoint control unit (MCU) for a video conference system is connected to other MCUs by logical links. If an application service selected by a terminal is not in a list of services on an application server connected to the MCU, the MCU communicates with the other MCUs to receive lists of services from application servers connected to the other MCUs and transmits them to the terminal.

### CROSS-REFERENCE TO RELATED APPLICATION

This application claims priority to and the benefit of Korean Patent Application No. 10-2013-0062018 filed in the Korean Intellectual Property Office on May 30, 2013, the entire contents of which are incorporated herein by reference.

### BACKGROUND OF THE INVENTION

(a) Field of the Invention

The present invention relates to a multipoint control unit and a service providing method thereof, and more particularly, to a technology that allows a multipoint control unit enabling three or more terminals to participate in a conference by providing services distributed over the internet to participants, in conjunction with an application server.

(b) Description of the Related Art

Conventional video conference and telepresence systems basically provide add-on services, such as document sharing, screen sharing, writing on a board, etc., that participants can use. Such add-on services are implemented in an MCU (multipoint control unit) that supports video conference or telepresence and made available to participants.

Users are increasingly demanding to use video conference and telepresence services, in connection with various internet services that have been already developed. Examples of the various internet services include a texting service, a captioning service, an automatic translation service, a VoD service, and so on. These add-on services are already commercially available on the internet. As long as they are provided in conjunction with application servers, it is possible to reduce development costs for adding these services to a video conference or telepresence system.

Most video conference and telepresence systems are configured in a closed-type service model, which is used in a specific domain. That is, a video conference system introduced by a particular organization (e.g., company, governmental organization, school, etc.) is a closed-type model that runs only in the organization using this system. This system does not have the capability to use a video conference service along with users of other systems in other organizations. If there is a way to enable interaction between different types of video conference or telepresence systems, and different types of video conference or telepresence systems are provided in conjunction with an associated internet application server, more internet services can be provided to video conference participants, without the development of add-on services.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a multipoint control unit which can provide more internet services to conference participants, and a service providing method thereof.

An exemplary embodiment of the present invention provides a method for a first MCU (multipoint control unit) to provide an application service in a video conference system including a plurality of MCUs connected by logical links over the internet. This service providing method includes: providing a video conference service to a plurality of terminals; checking whether or not an application service selected by one of the plurality of terminals is in a list of services on a first application server connected to the first MCU; if the application service is in the list of services, issuing an application service execution request to the first application server; and providing an execution result of the application service to the plurality of terminals.

The service providing method may further include, if the application service is not in the list of services, receiving an execution result of the application service through the other MCUs connected by the logical links.

The receiving may include: issuing a request for the application service to a plurality of second MCUs, besides the first MCU of the plurality of MCUs; and receiving, by the logical links, an execution result of the application service from the second MCUs connected to second application servers for executing the application service.

The checking may include providing a list of all services to the one terminal.

The providing may include: acquiring, from the first application server, a list of services on the first application server; and receiving, by the logical links, lists of services from the plurality of second application servers respectively connected to the plurality of second MCUs, besides the first MCU of the plurality of MCUs.

The application service may include at least one of services including a texting service, a captioning service, an automatic translation service, and a VoD service.

Another exemplary embodiment of the present invention provides a multipoint control unit which is connected to other multipoint control units by logical links. The multipoint control unit may include: a video conference service supporter that provides a video conference service to a plurality of terminals; and a service binder that provides an application service to the plurality of terminals according to an application service request from at least one of the plurality of terminals which are receiving the video conference service.

The service binder may check whether the application service is in a list of services on the first application server connected to the multipoint control unit, and if the application service is not in the list of services, may receive the application service through the other multipoint control units.

The multipoint control unit may further include a service router that communicates with the other multipoint control units by the logical links.

If the application service is in the list of services, the service binder may receive the application service from the first application server.

The multipoint control unit may further include: a service manager that acquires a list of services on the first application server; and a service router that transmits the list of services on the first application server to the other multipoint control units, and receives, by the logical links, lists of services from the second application servers connected to the other multipoint control units.

### BRIEF DESCRIPTION OF THE DRAWINGS

FIG. 1 is a view showing an example of a video conference system in accordance with an exemplary embodiment of the present invention.

FIG. 2 is a view showing an example of a video conference system in accordance with another exemplary embodiment of the present invention.

FIG. 3 is a view showing an example of another video conference system in accordance with an exemplary embodiment of the present invention.

FIG. 4 is a view showing an example of a video conference servicing method of a video conference system in accordance with an exemplary embodiment of the present invention.

FIG. 5 is a flowchart showing a method for an MCU to provide an application service in accordance with an exemplary embodiment of the present invention.

FIG. 6 is a view showing an example of a method of communication between MCUs in accordance with an exemplary embodiment of the present invention.

FIG. 7 is a view showing a method for an MCU to acquire a list of all services in accordance with an exemplary embodiment of the present invention.

FIG. 8 is a view showing an MCU in accordance with an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

Now, a multipoint control unit and a service providing method thereof in accordance with an exemplary embodiment of the present invention will be described in detail with reference to the drawings.

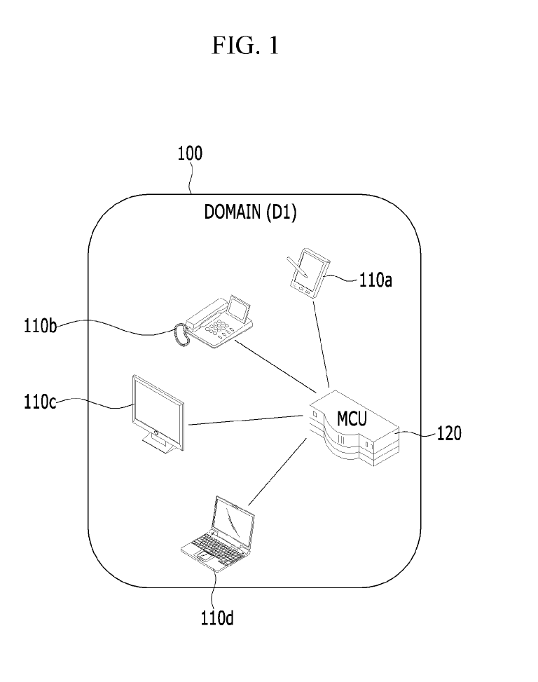

FIG. 1 is a view showing an example of a video conference system in accordance with an exemplary embodiment of the present invention.

Referring to FIG. 1, a video conference system 100 includes a plurality of terminals 110a to 110d and a multipoint control unit (MCU) 120 connected to the plurality of terminals 110a to 110d.

The terminals 110a to 110d support a camera, a speaker, and a microphone, respectively, and are devices that participants of a video conference service use.

The MCU 120 connects the terminals 110a to 110d and provides a video conference service, and transmits video and audio signals between the terminals 110a to 110d.

This video conference system 100 is a closed-type service system used in a particular domain D1, for which it is difficult to work in conjunction with a video conference system in other domains. However, a video conference between video conference systems in other domains may be available by using a service overlay network.

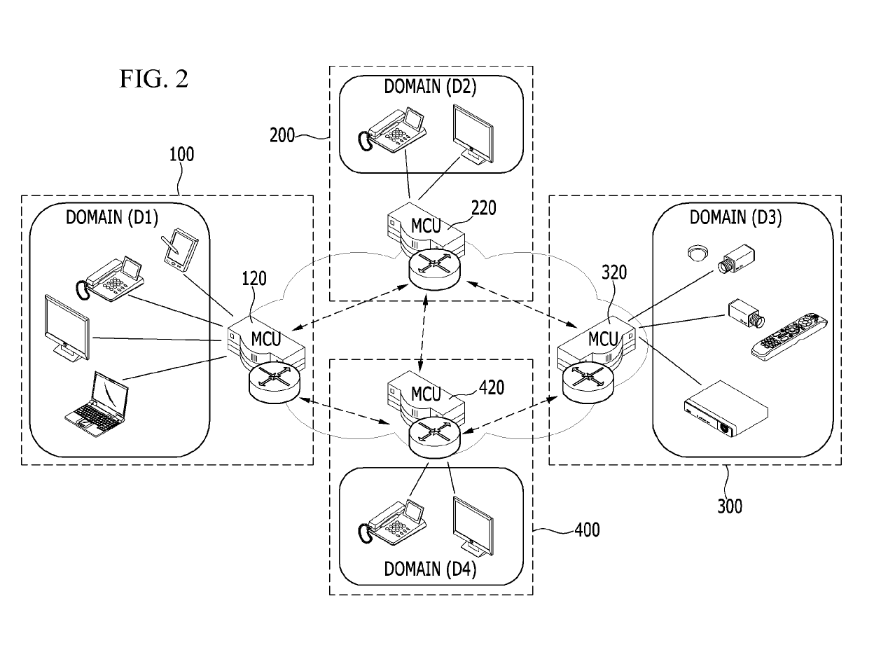

FIG. 2 is a view showing an example of a video conference system in accordance with another exemplary embodiment of the present invention.

Referring to FIG. 2, a service overlay network is built on top of a physical network, e.g., the internet, to provide a video conference service between video conference systems 100, 200, 300, and 400 of different domains D1 to D4.

The service overlay network is a virtual network built on top of the internet by connecting MCUs 120, 220, 320 and 420 of video conference systems 100, 200, 300, and 400 by logical links. Video conference between different domains is made available by sending and receiving video and audio signals between the MCUs 120, 220, 320 and 420 connected by logical links.

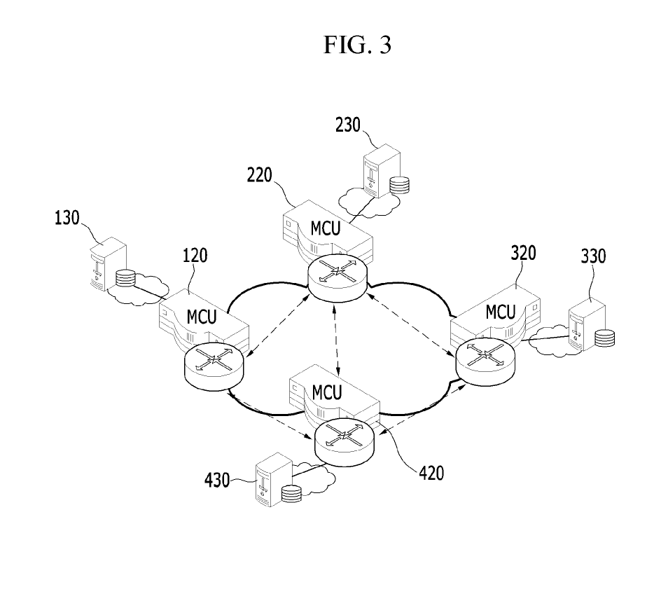

FIG. 3 is a view showing an example of another video conference system in accordance with an exemplary embodiment of the present invention.

Referring to FIG. 3, the MCUs 120, 220, 320, and 420 constituting the service overlay network may be connected to at least one 130, 230, 330, and 430 of developed application servers 130, 230, 330, and 430 over the internet. The MCUs 120, 220, 320, and 420 provide required application service to video conference participants, in conjunction with the connected application servers 130, 230, 330, and 430.

The application servers 130, 230, 330, and 430 correspond to servers that provide services provided by a specific service provider. Examples of the application servers 130, 230, 330, and 430 may include Google, Naver, KT, Daum, and so on.

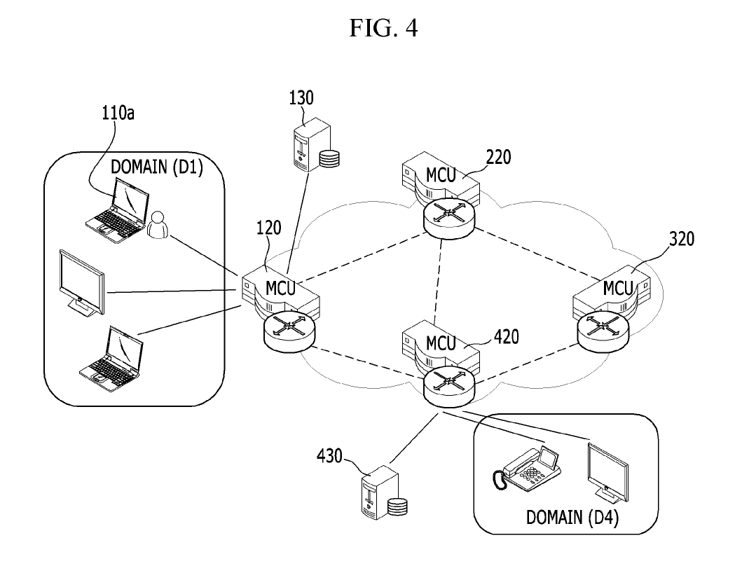

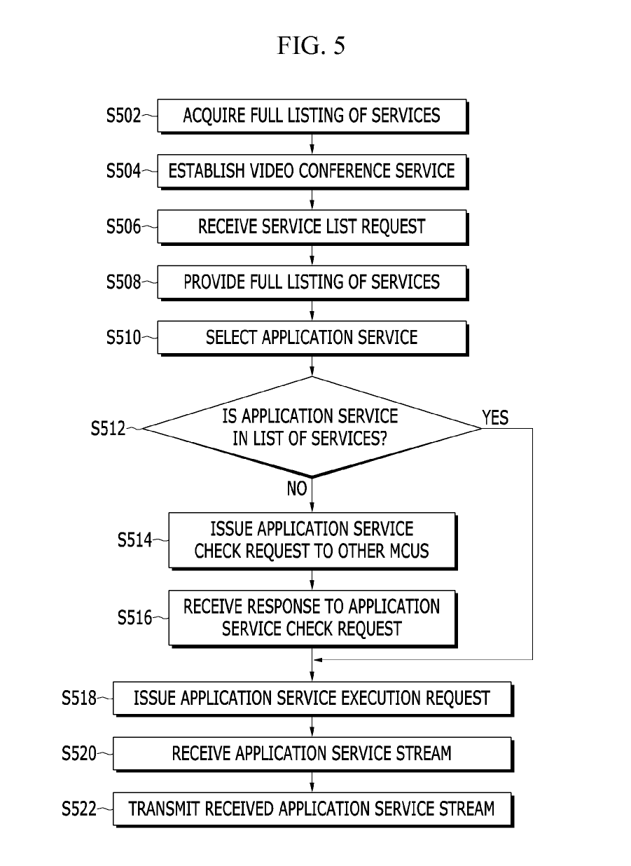

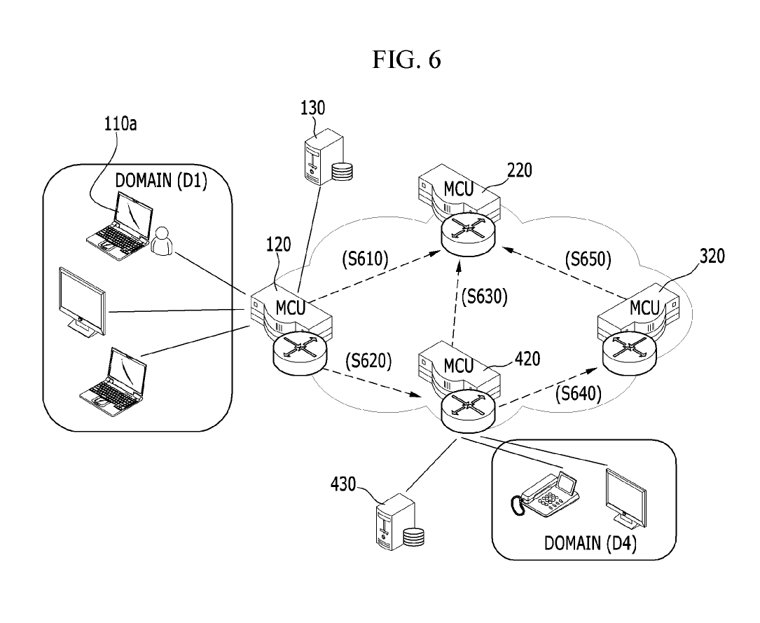

FIG. 4 is a view showing an example of a video conference servicing method of a video conference system in accordance with an exemplary embodiment of the present invention, FIG. 5 is a flowchart showing a method for an MCU to provide an application service in accordance with an exemplary embodiment of the present invention, and FIG. 6 is a view showing an example of a method of communication between MCUs in accordance with an exemplary embodiment of the present invention.

Referring to FIG. 4, a video conference service between two domains D1 and D4 can be established by a logical link between the MCUs 120 and 420.

Once a video conference service between the two domains D1 and D4 is established, the terminal 110a participating in the video conference service may issue an application service request to the MCU 120. Hereinbelow, a method of providing an application service will be described with respect to the MCU 120 and the user terminal 110a, for convenience of explanation.

Referring to FIG. 5, the MCU 120 acquires and manages a list of services available on the application server 130 connected to the MCU 120 and a list of all services (S502).

As shown in FIG. 4, once a video conference service between the two domains D1 and D4 is established (S504), the user terminal 110a participating in the video conference service may issue a service list request to the MCU 120.

Upon receiving the service list request from the user terminal 110a, the MCU 120 sends the list of all services to the user terminal 110a (S508).

The user terminal 110a selects a desired application service from the received list of all services, and notifies the MCU 120 of the selected application service.

Once the user terminal 110a selects an application service (S510), the MCU 120 checks whether or not the application service selected by the user terminal 110a is in the list of services available on the application server 130 connected to the MCU 120 (S512).

If the user-selected application service is in the list of services available on the application server 130, the MCU 120 issues a service execution request to the application server 130 (S518). Upon receiving the service execution request, the application server 130 executes the relevant application service, and transmits streams of the application service to the MCU 120.

Upon receiving the streams of the application service from the application server 130, the MCU 120 sends the received streams of the application service to the user terminal 110a (S522).

On the other hand, if the service selected by the user terminal 110a is not in the list of services available on the application server 130, the MCU 120 issues an application service check request to the other MCUs 220, 230, and 420 by a logical link regarding whether they are able to execute the application service selected by the user terminal 110a (S514).

Referring to FIG. 6, the MCU 120 transmits an application service check request to the MCUs 220 and 420 by connected logical links (S610 and S620), and the MCU 420 transmits an application service check request to the MCUs 220 and 320 by connected logical links (S630 and S640). Also, the MCU 320 transmits an application service check request to the MCU 220 by a connected logical link (S650). In this way, the application service check request from the MCU 120 is transmitted to all the other MCUs 220, 320, and 420.

Referring again to FIG. 5, upon receiving the application service check request, the MCUs 220, 320, and 420 each check whether the application service selected by the user terminal 110a is in the list of services available on each of the application servers 230, 330, and 430 connected to the MCUs 220, 320, and 420. A description will be made on the assumption that the service selected by the user terminal 110a is in the list of services available on the application server 430. The MCU 420 transmits a response to the application service check request indicating that the application service is executable to the MCU 120.

Upon receiving the response to the application service check request from the MCU 420 (S516), the MCU 120 issues an application service execution request to the MCU 420 (S518). The MCU 420 sends the service execution request to the application service 430, and upon receiving the application service execution request, the application server 430 executes the relevant application service, and transmits streams of the application service to the MCU 420. The MCU 420 transmits the streams of the service to the MCU 120.

Upon receiving the streams of the application service, the MCU 120 sends the received streams of the service to all the user terminals 110a to 110d participating in the video conference (S522).

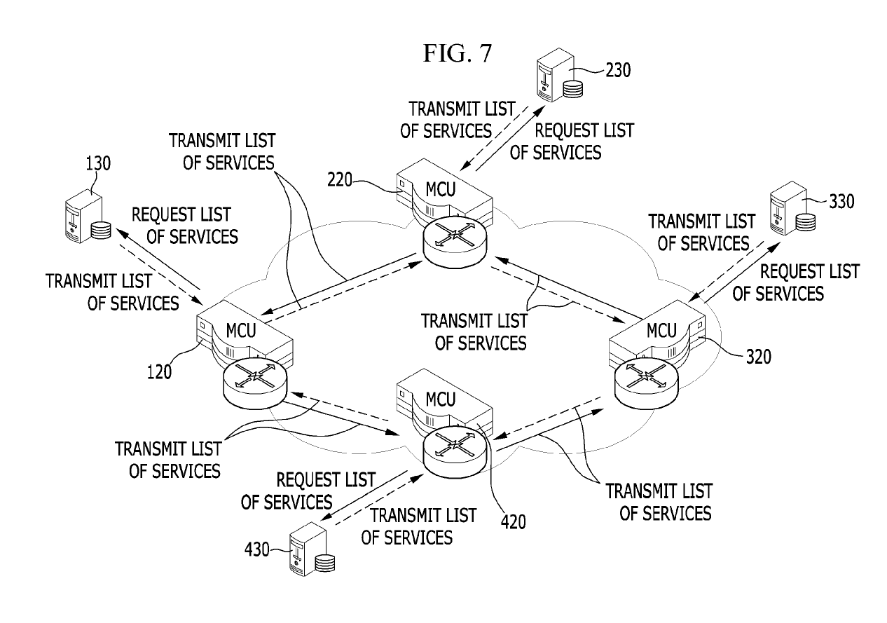

FIG. 7 is a view showing a method for an MCU to acquire a list of all services in accordance with an exemplary embodiment of the present invention.

Referring to FIG. 7, the MCU 120 issues a request for a list of available services to the application server 130, and acquires a list of services available on the application service 130 from the application server 130. The other MCUS 220, 320, and 420 also issue a request for a list of available services to the application servers 230, 330, and 430 connected to the MCUs 220, 320, and 420, and acquire the list of services available on the application server 130 from the application servers 230, 330, and 430. Moreover, the MCUs 120, 220, 320, and 420 can acquire a list of all services by exchanging lists of services acquired by logical links.

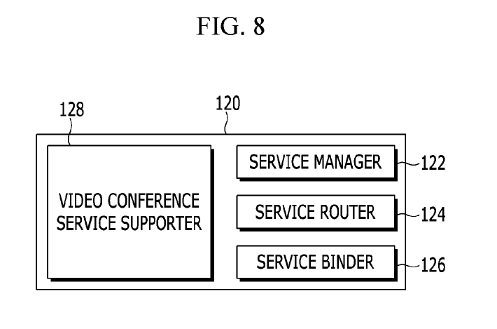

FIG. 8 is a view showing an MCU in accordance with an exemplary embodiment of the present invention.

FIG. 8 illustrates only one MCU 120 for convenience of explanation. The MCUs 220, 320, and 420 also may be configured in the same manner as the MCU 120.

Referring to FIG. 8, the MCU 120 includes a service manager 122, a service router 124, and a service binder 126. The MCU 120 further includes a video conference service supporter 128.

The service manager 122 stores and manages a list of services on the application server 130 and a list of all services. When there is a change in the status information of a list of available services, the application server 130 notifies the service manager 122 of such a change, so that the service manager 122 is able to store and manage the latest list of services on the application server 130.

The service router 124 supports communication with the MCUs 220, 320, and 420 in order to exchange lists of services with the other MCUs 220, 320, and 420. The service router 124 manages logical links, and performs communication with the MCUs 220 and 420 connected by the logical links.

The service binder 126 executes application services selected by the terminals 110a to 110d, and manages information required to issue an application service execution request. The service binder 126 performs an application service interface mapping function and a service execution result notification function. That is, upon an application service request from the terminal 110a, if the application service is in the list of services on the application server 130, the service binder 126 issues an application service request to the application server 130, and provides an execution result of the application service to the terminals 110a to 110d of all of the video conference participants. On the other hand, if the application service requested by the terminal 110a is not in the list of services on the application server 130, the service binder 126 receives an execution result of the relevant application service through the other MCUs 220, 320, and 420, and provides it to the terminals 110a to 110d of all of the video conference participants.

According to an embodiment of the present invention, users can be provided with video conference or telepresence which works in connection with various internet services. Unlike conventional video conference and telepresence systems, such video conference and telepresence systems provide already developed and commercially available services, without the development of an internet service, thereby reducing development costs.

Moreover, service providers can offer their services as add-ons to video conference system manufacturers and therefore use them as an additional profit model, and network service providers can create a new business model through users and service providers.

The exemplary embodiments of the present invention may also be implemented by a program realizing functions corresponding to the construction of the embodiment, and a recording medium on which the program is recorded, other than the device and/or method described above. Such implementation may be easily made from the disclosure of the above embodiments by those skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for a first MCU (multipoint control unit) to provide an application service in a video conference system comprising a plurality of MCUs connected by logical links over the internet, the method comprising:
providing video conference service to a plurality of terminals;
checking whether or not an application service selected by one of the plurality of terminals is in a list of services on a first application server connected to the first MCU;
if the application service is in the list of services, issuing an application service execution request to the first application server; and
providing an execution result of the application service to the plurality of terminals.

2. The method of claim 1, further comprising, if the application service is not in the list of services, receiving an execution result of the application service through the other MCUs connected by the logical links.

3. The method of claim 2, wherein the receiving comprises:
issuing a request for the application service to a plurality of second MCUs, besides the first MCU of the plurality of MCUs; and
receiving, by the logical links, an execution result of the application service from the second MCUs connected to second application servers for executing the application service.

4. The method of claim 1, wherein the checking comprises providing a list of all services to the one terminal.

5. The method of claim 4, wherein the providing comprises:
acquiring, from the first application server, a list of services on the first application server; and
receiving, by the logical links, lists of services from the plurality of second application servers respectively connected to the plurality of second MCUs, besides the first MCU of the plurality of MCUs.

6. The method of claim 1, wherein the application service comprises at least one of services including a texting service, a captioning service, an automatic translation service, and a VoD service.

7. A multipoint control unit which is connected to other multipoint control units by logical links, the multipoint control unit comprising:
a video conference service supporter that provides a video conference service to a plurality of terminals; and
a service binder that provides an application service to the plurality of terminals according to an application service request from at least one of the plurality of terminals which are receiving the video conference service.

8. The multipoint control unit of claim 7, wherein the service binder checks whether the application service is in a list of services on the first application server connected to the multipoint control unit, and if the application service is not in the list of services, receives the application service through the other multipoint control units.

9. The multipoint control unit of claim 8, further comprising a service router that communicates with the other multipoint control units by the logical links.

10. The multipoint control unit of claim 8, wherein, if the application service is in the list of services, the service binder receives the application service from the first application server.

11. The multipoint control unit of claim 8, further comprising:
a service manager that acquires a list of services on the first application server; and
a service router that transmits the list of services on the first application server to the other multipoint control units, and receives, by the logical links, lists of services from the second application servers connected to the other multipoint control units.

12. The multipoint control unit of claim 8, wherein the application service comprises at least one of services including a texting service, a captioning service, an automatic translation service, and a VoD service.
